(19) United States
(12) Patent Application Publication
(10) Pub. No.: US 2020/0112988 A1
(43) Pub. Date: Apr. 9, 2020

(54) User Equipment Initiated Listen-Before-Talk

(71) Applicant: Google LLC, Mountain View, CA (US)

(72) Inventors: Erik Richard Stauffer, Sunnyvale, CA (US); Jibing Wang, Saratoga, CA (US)

(73) Assignee: Google LLC, Mountain View, CA (US)

(21) Appl. No.: 16/153,549

(22) Filed: Oct. 5, 2018

(51) Int. Cl. H04W 74/08; H04W 72/04; H04W 72/08; H04B 17/318; H04W 74/00

(52) U.S. Cl. CPC H04W 74/0816; H04W 72/042; H04W 72/082; H04W 74/008; H04B 17/318; H04W 74/006; H04W 72/085

(57) ABSTRACT

The present disclosure describes systems and methods directed to a user equipment (UE) initiating a listen-before-talk mode at a base station. The described systems and methods include the UE determining that wireless-communication interferences proximate to the UE violate a criterion and sending, to the base station, a listen-before-talk request message that includes LBT control parameters. The base station then configures its wireless-communication components to perform downlink transmissions to the user equipment in a listen-before-talk mode that conforms to the LBT control parameters.

### BACKGROUND

The proliferation of wireless communications continues to increase levels of data exchange between wireless communication devices and, accordingly, congestion levels that may be affiliated with the exchange of data. In certain instances, a user equipment (UE), such as a smart phone, may be in range of multiple wireless communication devices transmitting data, such as a fifth-generation new radio (5G NR) base station, a third-generation long term evolution (3G LTE) base station, an internet-of-things (IoT) device, another UE, and the like. Under such conditions, wireless-communication interference local to the UE, which result from the multiple wireless communication devices transmitting data, may distort a signal intended for the UE, such as a downlink transmission of a signal from a base station to the UE.

During downlink transmissions of signals from the base station to the UE, it is common for the base station to perform beamforming operations. While performing beamforming operations, wireless-communication components of the base station may be “blind” to other signals that cause wireless-communication interference local to the UE and that potentially impede downlink transmissions from the base station.

For the base station to detect such wireless-communication interference, the base station may initiate a listen-before-talk (LBT) mode of operation. In this mode, the base station may re-configure its wireless-communication components to detect various sources of interference as well as interference parameters from the various sources. If the wireless-communication interference local to the UE violate a criterion local to the UE, the base station may delay downlink transmissions until the wireless-communication interference subside.

The base-station-initiated LBT mode, however, has multiple drawbacks. As one example, frequent re-configuration of the wireless-communication components of the base station may reduce wireless communication capacities of the base station, including downlink transmissions from the base station to other UEs as well as uplink transmissions from the other UEs to the base station. As another example, the base station detecting wireless-communication interference local to the UE may be unreliable due to the base station's remote nature from the UE, which may compound inaccuracies of detection hardware that is part of the base station. For at least the reasons above, the base-station initiated LBT mode is not effective or efficient across the spectrum of resources that support wireless communications.

### SUMMARY

The described systems and methods enable a user equipment (UE) to cause initiation of a listen-before-talk (LBT) mode at the base station that conforms with LBT control parameters that are based on wireless-communication interferences local to the UE. Using wireless-communication interferences that are local to the UE (measured in real-time, historic, or predicted due to expected increases in wireless communications local to the UE), an interference-manager application of the UE may cause the UE to estimate and provide the LBT control parameters to the base station via an LBT request message. Example LBT control parameters include signal-strength criterions, periodicities, frequency bands or bandwidths, and wireless-network loads.

In some aspects, a method performed by a user equipment communicating with a base station is described. The method comprises the user equipment determining that wireless-communication interferences proximate to the user equipment violate a criterion. After determining that the wireless-communication interferences violate the criterion, the user equipment sends, to the base station, a listen-before-talk request message that includes LBT control parameters. The LBT request message causes the base station to configure wireless-communication components of the base station to perform downlink transmissions to the user equipment in a listen-before-talk mode that conforms to the LBT control parameters.

In some other aspects, a method performed by a base station communicating with a user equipment is described. The method comprises the base station receiving, from the user equipment, a listen-before-talk request message that includes LBT control parameters. The base station then configures wireless-communication components of the base station to perform downlink transmissions to the user equipment in an LBT mode that conforms to the LBT control parameters, after which the base station performs the downlink transmissions to the user equipment in the LBT mode that conforms to the LBT control parameters.

In further aspects, a user equipment is described. The user equipment comprises a transceiver, a processor, and computer-readable storage media comprising instructions to implement an interference manager application. The interference manager application is configured to cause the user equipment to determine that wireless-communication interferences proximate to the user equipment violate a criterion. After determining that the wireless-communication interferences proximate to the user equipment violate the criterion, the interference manager application causes the user equipment to send, via the transceiver and to the base station, an LBT request message that includes LBT control parameters. The LBT request message causes the base station to configure wireless-communication components of the base station to perform downlink transmissions to the user equipment in an LBT mode that conforms to the LBT control parameters.

The details of one or more implementations are set forth in the accompanying drawings and the following description. Other features and advantages will be apparent from the description and drawings, and from the claims. This summary is provided to introduce subject matter that is further described in the Detailed Description and Drawings. Accordingly, a reader should not consider the summary to describe essential features nor limit the scope of the claimed subject matter.

### BRIEF DESCRIPTION OF THE DRAWINGS

This document describes details of one or more aspects of a user equipment (UE) initiating a listen-before-talk (LBT) mode at a base station wirelessly communicating with the UE. The use of the same reference numbers in different instances in the description and the figures may indicate like elements:

FIG. 1 illustrates an example operating environment in which various aspects of a user equipment (UE) initiating an LBT mode at a base station can be implemented.

FIG. 2 illustrates an example device diagram for devices that can implement various aspects of a user equipment (UE) initiating an LBT mode at a base station in accordance with one or more aspects.

FIG. 3 illustrates example details of a base station operating in an LBT mode in accordance with one or more aspects.

FIG. 4 illustrates additional example details of a base station operating in an LBT mode in accordance with one or more aspects.

FIG. 5 illustrates details of example signaling and control transactions of a user equipment (UE) initiating an LBT mode at a base station in accordance with one or more aspects.

FIG. 6 illustrates an example method performed by a user equipment in accordance with one or more aspects of the user equipment (UE) causing initiation of an LBT mode at a base station.

FIG. 7 illustrates an example method performed by a base station in accordance with one or more aspects of a user equipment (UE) causing initiation of an LBT mode at a base station.

FIG. 8 illustrates an example method performed by a base station in accordance with one or more aspects of the base station initiating an LBT mode at a user equipment (UE).

### DETAILED DESCRIPTION

The present disclosure describes systems and methods directed to a user equipment (UE) initiating a listen-before-talk (LBT) mode at a base station. The described systems and methods include the UE determining that wireless-communication interferences proximate to the UE violate a criterion and sending, to the base station, a listen-before-talk request message that includes LBT control parameters. The base station then configures its wireless-communication components to perform downlink transmissions to the user equipment in a listen-before-talk mode that conforms to the LBT control parameters.

An interference manager application is described in this document. The interference manager application may cause the UE to perform operations that are directed to causing the base station to perform downlink transmissions to the UE in the listen-before-talk mode that conforms to the LBT control parameters.

While features and concepts of the described systems and methods for such a protocol can be implemented in any number of different environments, systems, devices, and/or various configurations, aspects are described in the context of the following example devices, systems, and configurations.

### Operating Environment

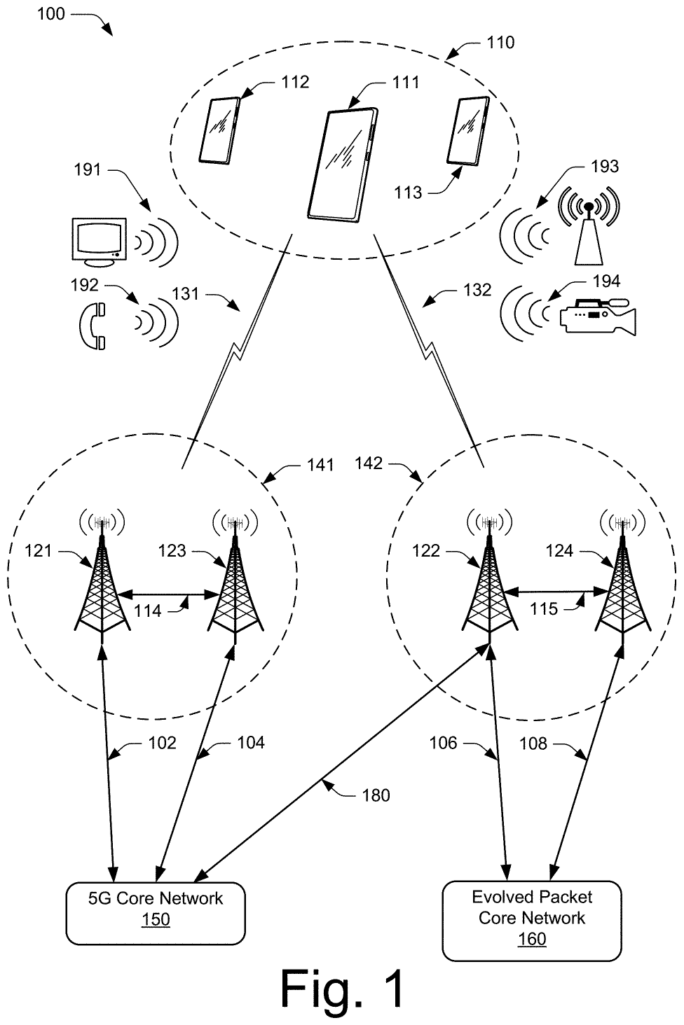

FIG. 1 illustrates an example environment 100, which includes multiple user equipment 110 (UE 110), illustrated as UE 111, UE 112, and UE 113. Each UE 110 can communicate with one or more base stations 120 (illustrated as base stations 121, 122, 123, and 124) through one or more wireless communication links 130 (wireless link 130), illustrated as wireless links 131 and 132. In this example, the UE 110 is implemented as a smailphone. Although illustrated as a smailphone, the UE 110 may be implemented as any suitable computing or electronic device, such as a mobile communication device, a modem, cellular phone, gaming device, navigation device, media device, laptop computer, desktop computer, tablet computer, smart appliance, vehicle-based communication system, and the like. The base stations 120 (e.g., an Evolved Universal Terrestrial Radio Access Network Node B, E-UTRAN Node B, evolved Node B, eNodeB, eNB, Next Generation Node B, gNode B, gNB, or the like) may be implemented in a macrocell, microcell, small cell, picocell, or the like, or any combination thereof.

The base stations 120 communicate with the UE 110 via the wireless links 131 and 132, which may be implemented as any suitable type of wireless link. The wireless link 131 and 132 can include a downlink of data and control information communicated from the base stations 120 to the UE 110, an uplink of other data and control information communicated from the UE 110 to the base station 120s, or both. The wireless links 130 may include one or more wireless links or bearers implemented using any suitable communication protocol or standard, or combination of communication protocols or standards such as 3rd Generation Partnership Project Long-Term Evolution (3GPP LTE), Fifth Generation New Radio (5G NR), and so forth. Multiple wireless links 130 may be aggregated in a carrier aggregation to provide a higher data rate for the UE 110. Multiple wireless links 130 from multiple base stations 120 may be configured for Coordinated Multipoint (CoMP) communication with the UE 110. Additionally, multiple wireless links 130 may be configured for single-RAT dual connectivity or multi-RAT dual connectivity (MR-DC).

The base stations 120 are collectively a Radio Access Network 140 (RAN, Evolved Universal Terrestrial Radio Access Network, E-UTRAN, 5G NR RAN or NR RAN). The RANs 140 are illustrated as a NR RAN 141 and an E-UTRAN 142. The base stations 121 and 123 in the NR RAN 141 are connected to a Fifth Generation Core 150 (5GC 150) network. The base stations 122 and 124 in the E-UTRAN 142 are connected to an Evolved Packet Core 160 (EPC 160). Optionally or additionally, the base station 122 may connect to both the 5GC 150 and EPC 160 networks.

The base stations 121 and 123 connect, at 102 and 104 respectively, to the 5GC 150 via an NG2 interface for control-plane signaling and via an NG3 interface for user-plane data communications. The base stations 122 and 124 connect, at 106 and 108 respectively, to the EPC 160 via an Si interface for control-plane signaling and user-plane data communications. Optionally or additionally, if the base station 122 connects to the 5GC 150 and EPC 160 networks, the base station 122 connects to the 5GC 150 via an NG2 interface for control-plane signaling and via an NG3 interface for user-plane data communications, at 180.

In addition to connections to core networks, base stations 120 may communicate with each other. The base stations 121 and 123 communicate via an Xn interface at 113. The base stations 122 and 124 communicate via an X2 interface at 115.

The 5GC 150 includes an Access and Mobility Management Function 152 (AMF 152) that provides control-plane functions such as registration and authentication of multiple UE 110, authorization, mobility management, or the like in the 5G NR network. The EPC 160 includes a Mobility Management Entity 162 (MME 162) that provides control-plane functions such as registration and authentication of multiple UE 110, authorization, mobility management, or the like in the E-UTRA network. The AMF 152 and the MME 162 communicate with the base stations 120 in the RANs 140 and also communicate with multiple UE 110, via the base stations 120.

Within the example environment 100, wireless signals from other wireless devices may interfere with the wireless links 130. As examples, and as illustrated in FIG. 1, a baby monitor signal 191, a cordless telephone signal 192, a wireless local area network (WLAN) access point signal 193, and a wireless video camera signal 194 are each radiating signals that create wireless-communication interference local to the UE 110. In some instances, the other wireless devices may use a listen-before-talk (LBT) technique.

In some aspects, the base station 120 may configure wireless-communication components of the base station 120 to perform downlink transmissions to the UE 110 in a listen-before-talk (LBT) mode in accordance with a set of listen-before-talk (LBT) control parameters. While in the LBT mode, the base station 120 may pause downlink transmissions to the UE 110 (e.g., transmission of signals to the UE 110 via the wireless link 130) and, prior to resuming downlink transmissions to the UE 110, monitor aspects of wireless communications according to the LBT control parameters. Such aspects of the wireless communications may include, for example, frequencies, signal strengths, identities or quantities of wireless communication devices, geographic regions of the wireless communications, time periods or time intervals, and the like.

Furthermore, the LBT control parameters may include one or more criterion that the base station 120 verifies is satisfied prior to performing another downlink transmission. As an example, the criterion may correspond to a threshold corresponding to a received signal strength indicator (RSSI)) or a quantity of wireless communication devices. As another example, the criterion may correspond to identities of wireless-communication devices or networks that have priority over downlink transmissions from base station 120. Other examples of the criterion include frequency bands not to be interfered with, security conditions to prevent an unauthorized wireless-communication device or network to cause wireless-communication interferences, or the like.

The UE 110 may determine the LBT control parameters (including the criterion) and provide the LBT control parameters to the base station 120 as part of an LBT request message. In some instances, determining the LBT control parameters may be based on real-time measurements of wireless-communication interferences proximate to the user equipment, inputs received from a user, past measurements of wireless-communication interferences proximate to the user equipment, future events that are projected to proximate to the UE 110, network reliability requirements, or the like.

The UE 110 may send the LBT request message (including the LBT control parameters) to the base station 120 in accordance with a wireless communication protocol. In accordance with a 5G NR wireless-communication protocol, for example, the UE 110 may send the LBT request message (including the LBT control parameters) to the base station 120 as part of an uplink radio resource control (UL RRC) message, a control element of a medium access control (MAC CE) message, or an uplink control information (UCI) message. In some instances, the wireless-communication protocol may designate a specific physical channel for such messages.

The LBT request message (including the LBT control parameters) may be initiated in response to the UE 110 determining that wireless-communication interferences proximate to the user equipment violate a criterion in real-time. For example, the UE 110 may determine, via a real-time measurement, that a signal strength (e.g., a received signal strength indicator (RSSI)) is below a threshold or that a quantity of wireless communication devices proximate to the UE 110 exceeds a threshold. In either example, the real-time measurement may indicate a violation of a criterion corresponding to an acceptable wireless-communication congestion level. The UE 110 may then determine LBT control parameters that include, for example, a time period (e.g., an immediate time period) for the base station 120 to configure itself to perform downlink communications in the LBT mode.

In other instances, the UE 110 may determine, via an estimate, that the wireless-communications interferences proximate to the UE 110 violate the criterion at a future point in time. In these other instances, the estimate may be based on past measurements corresponding to a received signal strength indicator (RSSI) proximate to a location of the user equipment, or a quantity of wireless-communication devices forecasted to be proximate to the location of the user equipment. In this example instance, the LBT control parameters included in the LBT request message may include a time period (e.g., a future time period) for the base station 120 to configure itself to perform downlink transmissions in the LBT mode.

Furthermore, in each of the aforementioned instances and after causing the base station 120 to perform the downlink transmissions in the LBT mode, the UE 110 may determine that the wireless-communication interferences proximate to the UE 110 no longer violate the criterion. Accordingly, the UE 110 may send a cancellation message that causes the base station 120 to configure its wireless-communication components to abstain from performing the downlink transmissions in the LBT mode.

### Example Mechanisms

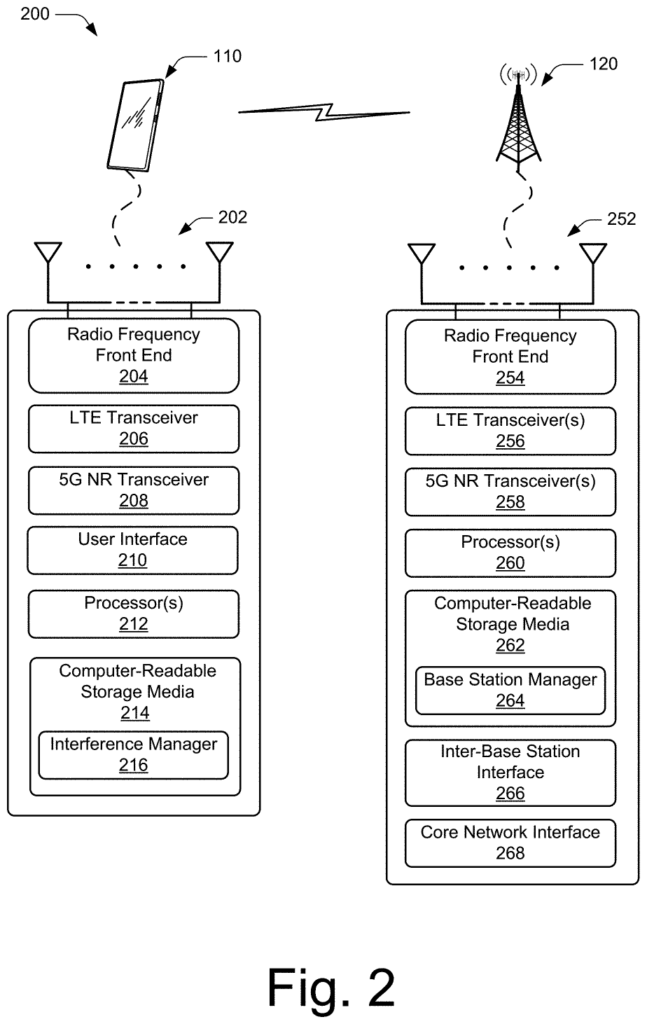

FIG. 2 illustrates an example device diagram 200 of the multiple UE 110 and the base stations 120. The multiple UE 110 and the base stations 120 may include additional functions and interfaces that are omitted from FIG. 2 for the sake of clarity. The UE 110 includes antennas 202, a radio frequency front end 204 (RF front end 204), an LTE transceiver 206, and a 5G NR transceiver 208 for communicating with base stations 120 in the 5G RAN 141 and/or the E-UTRAN 142. The RF front end 204 of the UE 110 can couple or connect the LTE transceiver 206, and the 5G NR transceiver 208 to the antennas 202 to facilitate various types of wireless communication. The antennas 202 of the UE 110 may include an array of multiple antennas that are configured similar to or differently from each other. The antennas 202 and the RF front end 204 can be tuned to, and/or be tunable to, one or more frequency bands defined by the 3GPP LTE and 5G NR communication standards and implemented by the LTE transceiver 206, and/or the 5G NR transceiver 208. Additionally, the antennas 202, the RF front end 204, the LTE transceiver 206, and/or the 5G NR transceiver 208 may be configured to detect conditions that may be associated with wireless-communication interferences proximate to the UE 110 and transmit an LBT request message to the base stations 120. By way of example and not limitation, the antennas 202 and the RF front end 204 can be implemented for operation in sub-gigahertz bands, sub-6 GHZ bands, and/or above 6 GHz bands that are defined by the 3GPP LTE and 5G NR communication standards.

The UE 110 further includes user interface 210 that receives inputs from a user of the UE 110. In some instanced, a user may input information that may define one or more aspects of the LBT control parameters. For example, input information may include wireless-communication device identifiers, vectors or coordinates defining a geographic region to be monitored, a threshold setting (such as a received signal strength indicator (RSSI) setting), or the like. In some instances, the user interface 210 includes a graphical user interface (GUI) that that receives the information via a touch input. In other instances, the user interface 210 includes an intelligent assistant that receives the information via an audible input.

The UE 110 also includes processor(s) 212 and computer-readable storage media 214 (CRM 214). The processor 212 may be a single core processor or a multiple core processor composed of a variety of materials, such as silicon, polysilicon, high-K dielectric, copper, and so on. The computer-readable storage media described herein excludes propagating signals. CRM 214 may include any suitable memory or storage device such as random-access memory (RAM), static RAM (SRAM), dynamic RAM (DRAM), non-volatile RAM (NVRAM), read-only memory (ROM), or Flash memory.

CRM 214 also includes executable code of an interference manager 216. Alternately or additionally, the interference manager 216 may be implemented in whole or part as hardware logic or circuitry integrated with or separate from other components of the UE 110. In at least some aspects, the UE 110, via the processor 210 executing the code of the interference manager 216, performs operations associated with managing wireless-communication interferences and transmitting LBT request messages in accordance with aspects described herein. For example, the interference manager 216 may direct the receivers in one or more of LTE transceiver 206 or 5G NR transceiver 208 to configure themselves to detect interference across a specified set of frequency bands and over a pre-determined period of time. This may be dynamic (e.g., in response to an initial interference reading during period T1, change one or more parameters during period T2) or static (e.g., measured predetermined parameters every period). The interference manager can use other inputs (e.g., location, time of the day, calendar or other applications, user input) to refine the LBT message contents.

The device diagram for the base stations 120, shown in FIG. 2, includes a single node (e.g., a gNode B). The functionality of the base stations 120 may be distributed across multiple network nodes or devices and may be distributed in any fashion suitable to perform the functions described herein. The base stations 120 include antennas 252, a radio frequency front end 254 (RF front end 254), one or more LTE transceivers 256, and/or one or more 5G NR transceivers 258 for communicating with the UE 110. The RF front end 254 of the base stations 120 can couple or connect the LTE transceivers 256 and the 5G NR transceivers 258 to the antennas 252 to facilitate various types of wireless communication. The antennas 252 of the base stations 120 may include an array of multiple antennas that are configured similar to or differently from each other. The antennas 252 and the RF front end 254 can be tuned to, and/or be tunable to, one or more frequency band defined by the 3GPP LTE and 5G NR communication standards, and implemented by the LTE transceivers 256, and/or the 5G NR transceivers 258. Additionally, the antennas 252, the RF front end 254, the LTE transceivers 256, and/or the 5G NR transceivers 258 may be configured to support beamforming, such as Massive-MIMO, for the transmission and reception of communications with the UE 110.

The base stations 120 also include processor(s) 260 and computer-readable storage media 262 (CRM 262). The processor 260 may be a single core processor or a multiple core processor composed of a variety of materials, such as silicon, polysilicon, high-K dielectric, copper, and so on. CRM 262 may include any suitable memory or storage device such as random-access memory (RAM), static RAM (SRAM), dynamic RAM (DRAM), non-volatile RAM (NVRAM), read-only memory (ROM), or Flash memory

CRM 262 also includes executable code of a base station manager 264. Alternately or additionally, the base station manager 264 may be implemented in whole or part as hardware logic or circuitry integrated with or separate from other components of the base stations 120. In at least some aspects, the base station 120 configures, via the processor 260 executing the code of the base station manager 264, the LTE transceivers 256 and the 5G NR transceivers 258 for wireless communications with the UE 110 and also such that the base station 120 performs downlink transmissions in accordance with aspects of the LBT mode described herein.

The base stations 120 also include an inter-base station interface 266, such as an Xn and/or X2 interface, which the base station manager 264 configures to exchange user-plane and control-plane data between another base station 120, to manage the communication of the base stations 120 with the UE 110. The base stations 120 include a core network interface 268 that the base station manager 264 configures to exchange user-plane and control-plane data with core network functions and entities.

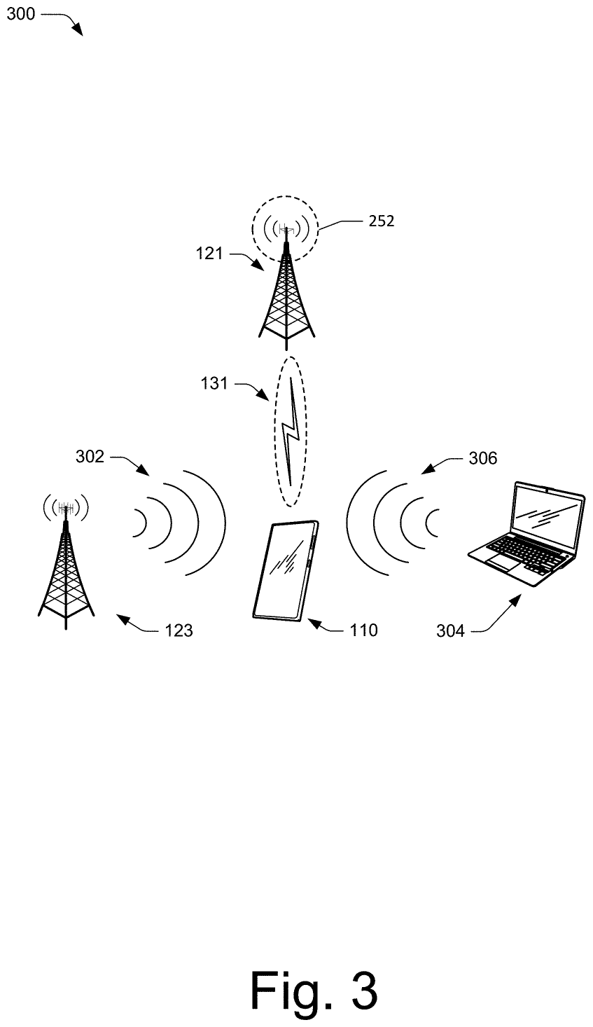

FIG. 3 illustrates example details 300 of a base station operating in an LBT mode in accordance with one or more aspects. The base station may be the base station 121 of FIG. 1 incorporating elements of FIG. 2.

As illustrated in FIG. 3., the base station 121 is performing downlink transmissions to the UE 110 via the wireless link 131. As part of the downlink transmissions, the base station 121 configures its wireless-communication components, including the antennas 252, to form beams (i.e., beamforming) to support the wireless communication link 131. While the base station is actively performing the downlink transmissions, the base station is performing in a “talk” mode.

Also illustrated in FIG. 3 are other example wireless-communication devices that transmitting signals that are proximate to the UE 110. Although not linked with the UE 110, base station 123 of FIG. 1 is transmitting a set of signals 302 that may interfere with the downlink transmissions (e.g., the wireless link 131) from the base station 121 to the UE 110. Also, as illustrated, a laptop computer 304 is transmitting another set of signals 306 that may interfere with the downlink transmissions from the base station 121 to the UE 110. The base station 123 and the laptop computer 304 are by way of example only, as other wireless-communication devices may also transmit sets of signals that may interfere with the downlink transmissions, such as Internet-of-Things (IoT) devices wirelessly communicating at low data rates with signals having with high latency tolerances.

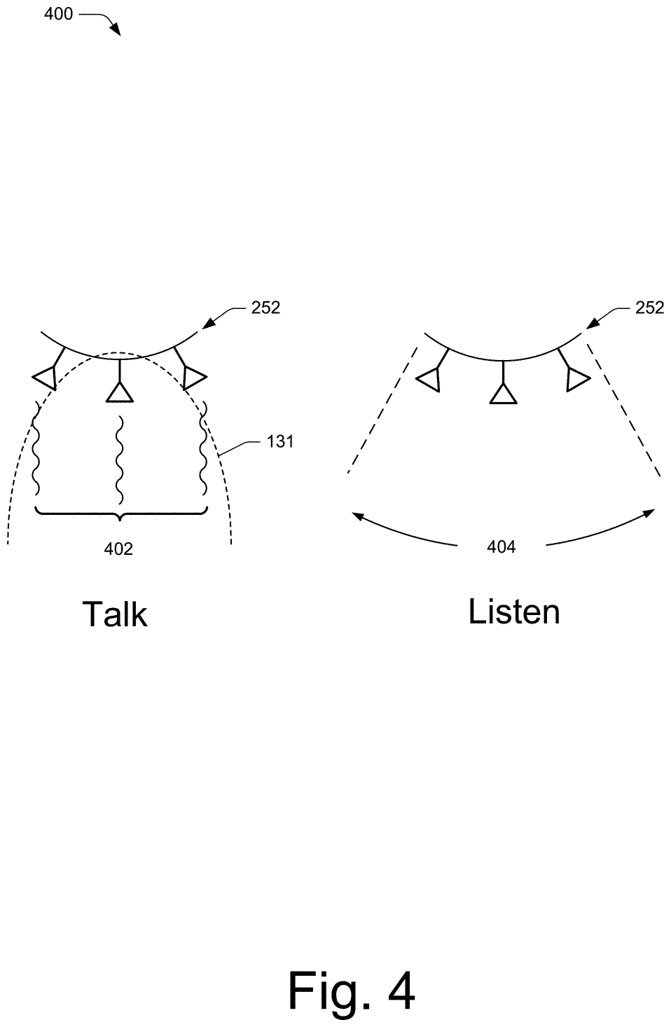

FIG. 4 illustrates example configurations of wireless-communication components of the base station 121 that correspond, respectively, to a talk mode and a listen mode. As illustrated in FIG. 4, while the base station 121 performs the downlink transmissions (e.g., performs the downlink transmissions in a talk mode) a set of electromagnetic waves 402 radiates from a subset of the antennas 252. Via constructive and destructive interference principles, the subset of the antennas 252 directionally form a wireless link (e.g., the wireless link 131) to improve qualities of the downlink transmissions from the base station 121 to the UE 110. While the subset of the antennas 252 is actively radiating the electromagnetic waves 402, the subset of the antennas 252 is not able to detect other electromagnetic waves that may be associated with other signals.

Also illustrated in FIG. 4 is an example configuration of the base station 121 configured to perform in a listen mode. As illustrated, the subset of the antennas 252 is not actively radiating electromagnetic waves and may receive or detect electromagnetic waves that are radiated from the radial direction 404. In this configuration and in the context of the ongoing example, the base station 120 may monitor a geographic region (corresponding to the radial direction 404).

In general, a configuration of the base station 121 may alternate between the schematically-illustrated listen mode and the schematically-illustrated talk mode to perform in an LBT mode. It is to be further understood that a myriad of LBT modes are available to the base station 121. LBT control parameters, as implemented by the base station 121, may define each LBT mode (of the myriad of available LBT modes). Examples of such LBT control parameters may include time periods, time intervals, geographic regions, wireless-communication devices, and conditions to be monitored by the base station.

### UE Initiated Listen-Before-Talk Mode Signaling and Control Transactions

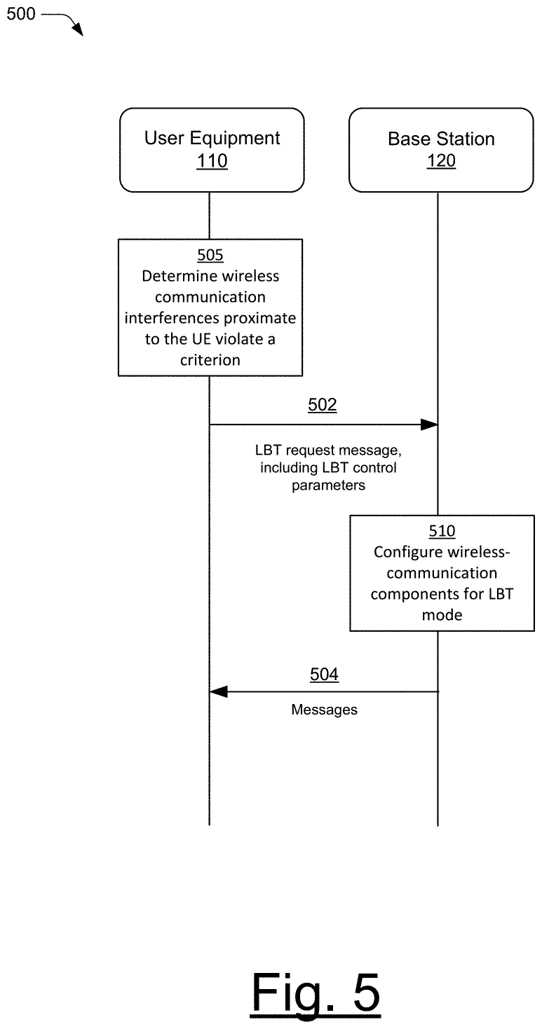

FIG. 5 illustrates details 500 of example signaling and control transactions of a user equipment (UE) initiating an LBT mode at a base station in accordance with one or more aspects. The UE may be the UE 110 of FIG. 1 and the base station may be the base station 120 of FIG. 1.

Prior to initiating signal and control transactions, the UE 110 determines that wireless-communication interferences proximate to the UE violate a criterion.

At 502, the UE 110 transmits to the base station 120 an LBT request message. The LBT request message includes LBT control parameters.

In response to receiving the message (e.g., the message transmitted by the UE 110 at 502), the base station 120 configures its wireless-communication components to perform in an LBT mode in accordance with the LBT control parameters.

At 504, after configuring its wireless-communication components, the base station 120 transmits messages to the UE 110. The act of performing the transmissions, by the base station, conforms with at least one of the LBT control parameters received in the LBT request message. Depending on additional information available to the base station 120, the base station 120 may choose to augment or reduce implementation of LBT control parameters received in the LBT request message. For example, the base station 120 may not implement each parameter received in the LBT request message. As another example, the base station 120 may implement a provided parameter but use a sub-range instead of the range provided (e.g., a subset of the frequency band provided in the LBT request message or a periodicity that is a multiple of the periodicity provided in the LBT request message).

### UE Initiated Listen-Before-Talk Mode Methods

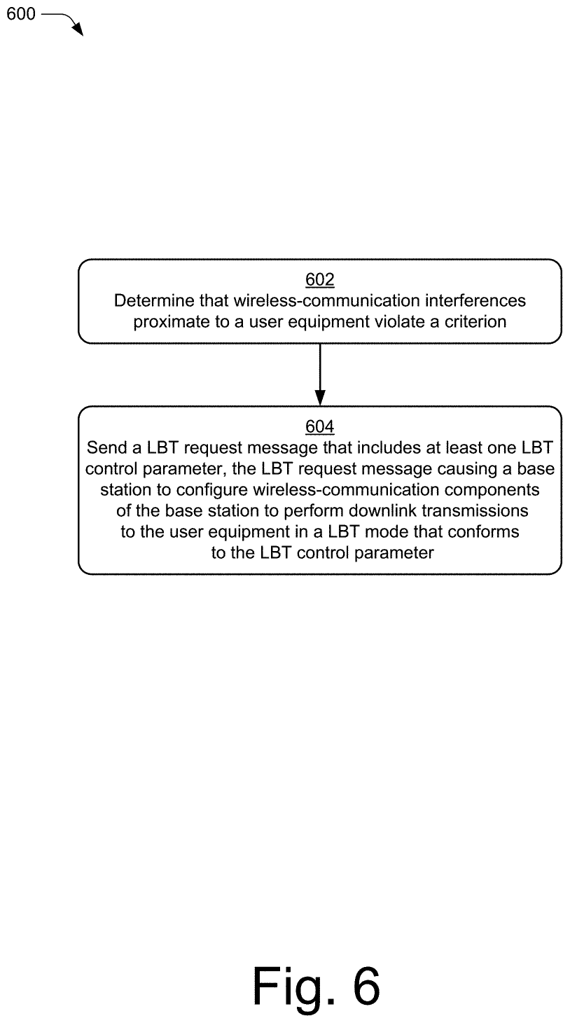

FIG. 6 illustrates an example method 600 performed by a user equipment in accordance with one or more aspects of the user equipment (UE) initiating an LBT mode at a base station. The method may be performed by the UE 110 of FIG. 1, using elements of FIG. 2.

At 602 the UE 110 (e.g., the processor 212 executing the code of the interference manager 216) determines that wireless-communication interferences proximate to the UE 110 violate a criterion.

By way of example and in certain instances, the determination may be based on a real-time measurement made by the UE 110 (e.g., a measurement made by circuitry included in the LTE transceiver 206 or the 5G NR transceiver 208), such as a detected strength of a signal or a detected quantity of wireless-communication devices that are proximate to the UE 110.

In other example instances, the determination may be based on an estimate made by the UE 110. In these instances, the interference manager 216 may retrieve information, such as a past measurement corresponding to a received signal strength indicator (RSSI) proximate to a location of the user equipment or a quantity of wireless-communication devices proximate to the location of the UE 110, to make the determination. The interference manager 216 may, alternatively, retrieve information associated with a future event that indicates wireless-communication traffic proximate to the UE 110 is expected to increase. The interference manager 216 may apply techniques that include machine-learning, artificial intelligence, or predetermined algorithms to the retrieved information to calculate the estimate.

The criterion may be provided to the UE 110 by the base station 120. Alternatively, the criterion may be provided to the UE 110 by a user of the UE 110 (e.g., the UE 110 may receive a setting for the criterion via the user interface 210 of the UE 110).

At 604, the UE 110 sends, to the base station 120, an LBT request message that includes LBT control parameters. Sending the LBT request message causes the base station 120 to configure wireless-communication components of the base station 120 to perform downlink transmissions to the UE 110 in an LBT mode that conforms to the LBT control parameters.

The LBT control parameters may include information that causes the base station 120 to configure its transceiver (e.g., LTE transceiver 256 or 5G NR transceiver 258) to monitor a geographic region, a frequency, a time period, a time interval, another user equipment, another network, or the like. The LBT control parameters may indicate where over-the-threshold wireless-communication interference is found (e.g., along a time dimension, along a frequency dimension, in a geographic dimension, and by magnitude of signal strength or number of devices) or may conversely indicate where wireless-communication interference is not found that violates the criterion.

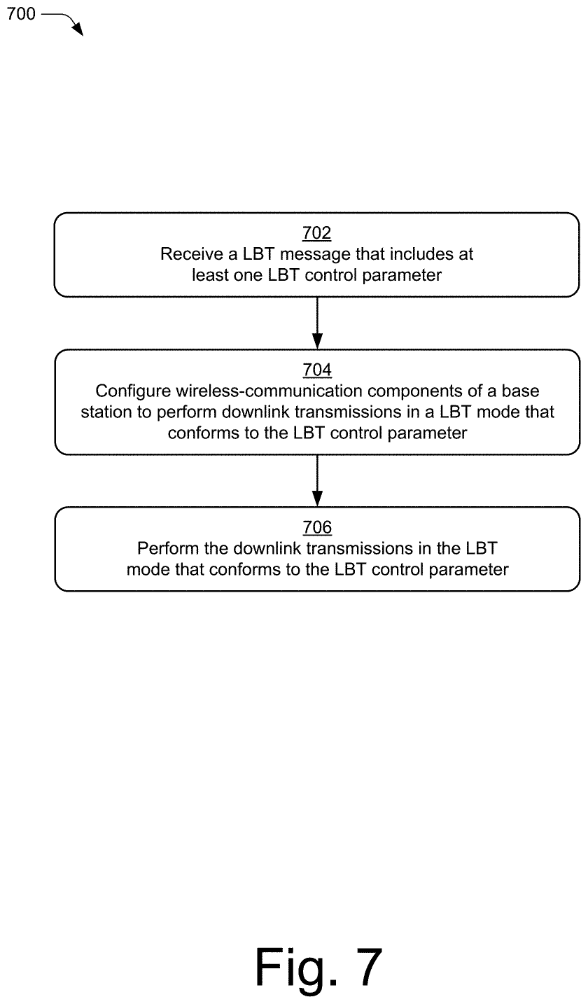

FIG. 7 illustrates an example method 700 performed by a base station in accordance with one or more aspects of a user equipment (UE) causing initiation of an LBT mode at a base station. The method may be performed by the base station 120 of FIG. 1, using elements of FIG. 2.

At operation 702, the base station 120 (e.g., the LTE transceiver 256 or the 5G NR transceiver 258) receives, from the UE 110, an LBT request message that includes LBT control parameters. By way of example and in certain instances, the LBT control parameters may cause the base station 120 to monitor a geographic region, a frequency, a time period, a time interval, a presence of another user equipment, a presence of another network, a presence of another base station, or the like. In some instances, monitoring the presence of other devices may include monitoring identies of other devices for security purposes. The LBT control parameters may furthermore include one or more criterion for the base station 120 to verify are satisfied prior to performing a downlink transmission.

At operation 704, the base station 120 (e.g., the processor 260 executing the code of the base station manager 264) configures wireless-communication components of the base station, which may include one or more of the LTE transceiver 256 and the 5G NR transceiver 258, to perform downlink transmissions to the user equipment 110 in an LBT mode that conforms to the LBT control parameters.

At operation 706, the base station 120 performs downlink transmissions to the UE 110 in the LBT mode that conforms to the LBT control parameters.

### Variations

Although the above described systems and methods are in the context of a user equipment initiating an LBT mode at a base station, the described systems and methods are non-limiting and may apply to other contexts or wireless-communication environments.

As an example, determining that wireless-communication interferences violate a local criterion and sending an LBT request message may involve wireless-communication devices that are neither a base station or a user equipment. In this other example variation, the wireless-communication devices may be Internet-of-Things (IoT) devices wirelessly communicating at low data rates with signals having with high latency tolerances.

Another example variation may include a base station determining that wireless-communication interferences local to the base station violate a criterion and sending an LBT request message to a user equipment (or another wireless-communication device). In this example, and following techniques described herein, the LBT request message can cause the user equipment (or other wireless-communication device) to perform uplink transmissions in an LBT mode that conforms to LBT control parameters included in the LBT request message.

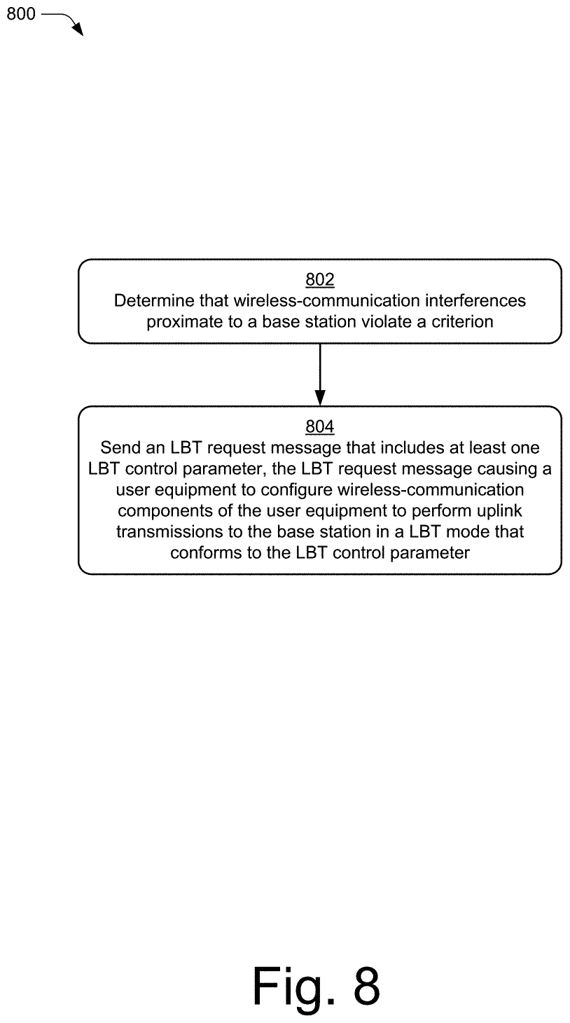

FIG. 8 illustrates an example method 800 performed by a base station in accordance with one or more aspects of the base station initiating an LBT mode at a user equipment. The method may be performed by the base station 120 of FIG. 1, using elements of FIG. 2.

At 802 the base station 120 (e.g., the processor 260 executing the code of the base station manager 264, which in this example instance includes interference management capabilities) determines that wireless-communication interferences proximate to the base station 120 violate a criterion.

By way of example and in certain instances, the determination may be based on a real-time measurement made by the base station 120 (e.g., a measurement made by circuitry included in the LTE transceiver 256 or the 5G NR transceiver 258), such as a detected strength of a signal or a detected quantity of wireless-communication devices that are proximate to the base station 120.

In other example instances, the determination may be based on an estimate made by the base station 120. In these instances, the base station manager 264 may retrieve information, such as a past measurement corresponding to a received signal strength indicator (RSSI) proximate to a location of the base station 120 or a quantity of wireless-communication devices proximate to a location of the base station 120, to make the determination. The base station manager 264 may, alternatively, retrieve information associated with a future event that indicates wireless-communication traffic proximate to the base station 120 is expected to increase. The base station manager 264 may apply techniques that include machine-learning, artificial intelligence, or predetermined algorithms to the retrieved information to calculate the estimate.

At 804, the base station 120 sends, to the UE 110, an LBT request message that includes LBT control parameters. Sending the LBT request message causes the UE 110 to configure wireless-communication components of the UE 110 to perform uplink transmissions to base station 120 in an LBT mode that conforms to the LBT control parameters.

The LBT control parameters may include information that causes the UE 110 to configure its transceiver (e.g., the LTE transceiver 206 or the 5G NR transceiver 208) to monitor a geographic region, a frequency, a time period, a time interval, another user equipment, another network, or the like. The LBT control parameters may indicate where over-the-threshold wireless-communication interference is found (e.g., along a time dimension, along a frequency dimension, in a geographic dimension, and by magnitude of signal strength or number of devices) or may conversely indicate where wireless-communication interference is not found that violates the criterion.

Although aspects of a user equipment initiated LBT mode have described in language specific to features and/or methods, the subject of the appended claims is not necessarily limited to the specific features or methods described. Rather, the specific features and methods are disclosed as example implementations of the LBT mode, and other equivalent features and methods are intended to be within the scope of the appended claims. Further, various different aspects are described, and it is to be appreciated that each described aspect can be implemented independently or in connection with other described aspects.

What is claimed is:

1. A method performed by a user equipment communicating wirelessly with a base station, the method comprising:
determining, by the user equipment, that wireless-communication interferences proximate to the user equipment violate a criterion; and
sending, by the user equipment and to the base station, a listen-before-talk (LBT) request message that includes at least one LBT control parameter, the LBT request message causing the base station to configure wireless-communication components of the base station to perform downlink transmissions to the user equipment in an LBT mode that conforms to the LBT control parameter.

2. The method as recited in claim 1, wherein determining that the wireless-communications interferences proximate to the user equipment violate the criterion is based on a real-time measurement made by the user equipment.

3. The method as recited in claim 2, wherein the criterion is a threshold of a received signal strength indicator (RSSI) of at least one signal that is detected by the user equipment.

4. The method as recited in claim 2, wherein the criterion is a threshold of a quantity of wireless-communication devices that is detected by the user equipment.

5. The method as recited in claim 1, wherein determining that the wireless-communications interferences proximate to the user equipment violate the criterion is based on an estimate made by the user equipment, the criterion a threshold and the estimate based on:
past measurements corresponding to a received signal strength indicator (RSSI) proximate to a location of the user equipment; or a quantity of wireless-communication devices forecasted to be proximate to the location of the user equipment.

6. The method as recited in claim 5, wherein the estimate is based on future events proximate to a location of the user equipment.

7. The method as recited by claim 1, further comprising the user equipment receiving, from the base station, a message transmitted by the base station performing the downlink transmissions in the LBT mode that conforms to the LBT control parameter.

8. A method performed by a base station communicating wirelessly with a user equipment, the method comprising:
receiving, by the base station and from the user equipment, a listen-before-talk (LBT) request message that includes at least one LBT control parameter;
configuring, by the base station, wireless-communication components of the base station to perform downlink transmissions to the user equipment in an LBT mode that conforms to the LBT control parameter; and
performing, by the base station, the downlink transmissions to the user equipment in the LBT mode that conforms to the LBT control parameter.

9. The method as recited in claim 8, wherein the LBT control parameters cause to base station to configure the wireless-communication components of the base station to monitor wireless communications for a signal having a determined frequency while the base station performs the downlink transmissions in LBT mode.

10. The method as recited in claim 8, wherein the LBT control parameters cause the base station to configure the wireless-communication components of the base station to perform the downlink transmissions in the LBT mode for a determined time period or during determined time intervals.

11. The method as recited in claim 8, wherein the LBT control parameters cause the base station to configure the wireless-communication components of the base station to monitor wireless communications to detect a presence of another user equipment, a presence of another base station, or a presence of a network while the base station performs the downlink transmissions in the LBT mode.

12. The method as recited in claim 8, wherein the LBT control parameters cause the base station to perform the downlink transmissions in the LBT mode in accordance with a wireless-communication interference criterion.

13. The method as recited in claim 12, wherein the criterion is determined by the base station and provided to the user equipment by the base station.

14. A method performed by a base station communicating wirelessly with a user equipment, the method comprising:
determining, by the base station, that wireless-communication interferences proximate to the base station violate a criterion; and
sending, by the base station and to the user equipment, a listen-before-talk (LBT) request message that includes at least one LBT control parameter, the LBT request message causing the user equipment to configure wireless-communication components of the user equipment to perform uplink transmissions to the base station in an LBT mode that conforms to the LBT control parameter.

15. The method as recited in claim 14, wherein determining that the wireless-communications interferences proximate to the base station violate the criterion is based on a real-time measurement made by the base station.

16. The method as recited in claim 15, wherein the criterion is a threshold of a received signal strength indicator (RSSI) of at least one signal that is detected by the base station.

17. The method as recited in claim 15, wherein the criterion is a threshold of a quantity of wireless-communication devices that is detected by the base station.

18. The method as recited in claim 14, wherein determining that the wireless-communications interferences proximate to the base station violate the criterion is based on an estimate made by the base station, the criterion a threshold and the estimate based on:
past measurements corresponding to a received signal strength indicator (RSSI) proximate to a location of the base station; or
a quantity of wireless-communication devices forecasted to be proximate to the location of the base station.

19. The method as recited in claim 18, wherein the estimate is based on future events proximate to the location of the base station.

20. The method as recited by claim 14, further comprising the base station receiving, from the user equipment, a message transmitted by the user equipment performing the uplink transmissions in the LBT mode that conforms to the LBT control parameter.
